(19) United States
(12) Patent Application Publication
(10) Pub. No.: US 2015/0138337 A1
(43) Pub. Date: May 21, 2015

(54) Imaging-Based Measurement Device

(71) Applicants: Schlumberger Technology Corporation, Sugar land, TX (US); The University of Tokyo, Bunkyo-ku (JP)

(72) Inventors: Theodorus Tjhang, Kita-ku (JP); Tsutomu Yamate, Yokohama-shi (JP); Osamu Osawa, Setagaya-ku (JP); Masatoshi Ishikawa, Kashiwa-shi (JP); Yoshihiro Watanabe, Katsushika-ku (JP)

(21) Appl. No.: 14/539,929

(22) Filed: Nov. 12, 2014

Related U.S. Application Data
(60) Provisional application No. 61/904,991, filed on Nov. 15, 2013.

(51) Int. Cl. E21B 47/00; E21B 47/12; H04N 7/18; E21B 43/16

(52) U.S. Cl. CPC E21B 47/0002; E21B 43/16; E21B 47/12; H04N 7/183; H04N 2005/2255
USPC 348/85; 166/305.1

(57) ABSTRACT

A fluid separator separates a fluid flow into a plurality of fluid portions, and delivers at least a first fluid portion of the plurality of fluids to a flow conduit. An imaging-based measurement device includes a light source and an image sensor. The imaging-based measurement device measures the first fluid portion in the flow conduit. An imaging processor in the imaging-based measurement device processes the measurement data to determine a characteristic of the first fluid portion.

### CROSS-REFERENCE TO RELATED APPLICATION

This application claims the benefit under 35 U.S.C. §119(e) of U.S. Provisional Application No. 61/904,991, entitled “Fluid Measurement System with Subsurface Particle Detection and Method of Using Same,” filed Nov. 15, 2013, which is hereby incorporated by reference.

### BACKGROUND

Wells can be drilled into a subsurface formation to allow communication with one or more reservoirs in the subsurface formation. A production well is used to produce fluids from the reservoir(s). An injector well can be used to inject fluids into the reservoir(s).

### SUMMARY

In general, according to some implementations, a fluid separator separates a fluid flow into a plurality of fluid portions, and delivers at least a first fluid portion of the plurality of fluids to a flow conduit. An imaging-based measurement device includes a light source and an image sensor, the imaging-based measurement device to measure the first fluid portion in the flow conduit.

In general, according to further implementations, an imaging-based measurement device including light sources and an image sensor measures content of a fluid portion in a flow conduit, the light sources to emit light at different wavelengths. The imaging-based measurement device determines, based on measurement data from the image sensor that is responsive to light from the light sources, characteristics of particles in the fluid portion.

In general, according to further implementations, measurement data acquired by an imaging-based measurement device including a light source and an image sensor is received, where the imaging-based measurement device measures a fluid portion in a flow conduit, the fluid portion separated from a fluid flow by a fluid separator. An imaging processor in the imaging-based measurement device uses the measurement data to determine a characteristic of the fluid portion.

Other or additional features will become apparent from the following description, from the drawings, and from the claims.

### BRIEF DESCRIPTION OF THE DRAWINGS

Some implementations are described with respect to the following figures.

FIG. 1 is a schematic diagram of a subsea wellsite arrangement that includes a fluid measurement system according to some implementations.

FIG. 2 is a block diagram of a fluid measurement system including a surface controller and a remote imaging-based measurement device, according to some implementations.

FIG. 3 is a block diagram of an example arrangement that includes an imaging-based measurement device for measuring content of a fluid in a flow conduit, according to some implementations.

FIG. 4 is a graph showing light pulses and exposure time windows of an image sensor, according to some implementations.

FIG. 5 is a block diagram of an example arrangement that includes an imaging-based measurement device for measuring content of a fluid in a fluid conduit, according to further implementations.

FIG. 6 is a graph showing light pulses at different discrete wavelengths and exposure time windows of an image sensor, according to further implementations.

FIG. 7 is a schematic diagram of an image window of measurement data acquired by an image sensor in response to light pulses emitted at different discrete wavelengths, according to some implementations.

FIG. 8 is a schematic diagram illustrating separation of an image into multiple images using color filtering, according to further implementations.

FIG. 9 is a schematic diagram of an imaging-based measurement device that performs fluorescence measurement, according to further implementations.

FIG. 10 is a block diagram of an example computer system, according to some implementations.

### DETAILED DESCRIPTION

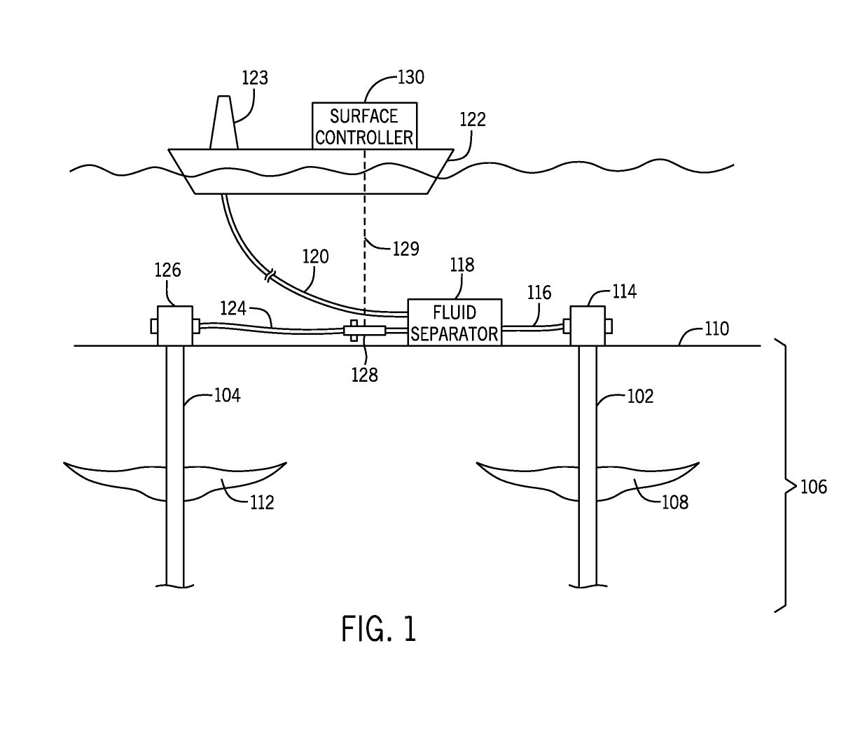

FIG. 1 is a schematic diagram showing a subsea wellsite arrangement that includes a production well 102 and an injection well 104 that have been drilled into a subsurface formation 106. Although just one production well 102 and/or injection well 104 are depicted in FIG. 1, it is noted that there can be more than one production well and/or more than one injection well in other examples.

Also, although FIG. 1 shows techniques or mechanisms according to some implementations being used in a subsea context, it is noted that in other examples, techniques or mechanisms according to some implementations can be used with a land-based wellsite arrangement.

The production well 102 is able to produce fluids (e.g. hydrocarbons such as oil and/or gas, or other types of fluids) from a reservoir 108 towards a surface, which in the example of FIG. 1 is a water bottom surface 110 (e.g., seafloor). The injector well 104 can be used to inject fluids into a reservoir 112. Although just one reservoir 108 and one reservoir 112 are depicted in association with the production well 102 and the injection well 104, respectively, it is noted that in other examples, the production well 102 can produce fluids from multiple reservoirs, and/or the injection well 104 can inject fluid into multiple reservoirs.

At the water bottom surface 110, wellhead equipment 114 is provided. Fluid produced from the reservoir 108 flows up through the production well 102 to the wellhead equipment 114. The production fluids pass through the wellhead equipment 114 to a flow conduit 116 that is attached to and in fluid communication with the wellhead equipment 114. The flow conduit 116 can include a pipe, a flowline, and so forth.

The fluid conduit 116 is further connected to and in fluid communication with a fluid separator 118, which receives fluid flow from the fluid conduit 116. The fluid separator 118 separates the received fluid flow into multiple separated fluid portions. In some examples, the fluid separator 118 is used for separating hydrocarbons from water that may be present in the fluid flow received from the flow conduit 116. The hydrocarbons can include oil and/or gas. The fluid separator 118 separates the fluid flow in the flow conduit 116 into (1) a first separated fluid portion that is provided to a production flow conduit 120, and (2) a second separated fluid portion that is provided to an injection flow conduit 124. Separation of a fluid flow into hydrocarbons and water can be based on the specific gravity difference between the hydrocarbons and the water.

Each of the flow conduits 120 and 124 can include a pipe, a flowline, and so forth. The injection flow conduit 120 runs from the fluid separator 118 to a surface marine vessel 122 (e.g. a sea platform, a ship, etc.). The first separated fluid portion that is delivered through the production flow conduit 120 can include oil and/or gas, for example. The marine vessel 122 includes production equipment 123 that can extract the hydrocarbons from the production flow conduit 120 for storage in storage tanks on the marine vessel 122.

The second separated fluid portion passed through the injection flow conduit 124 to injection wellhead equipment 126. The second separated fluid includes primarily a target fluid (or target fluids), due to the fluid separation performed by the fluid separator 118. For example, the target fluid can include water. The second separated fluid portion is flowed through the injection flow conduit 124 and the injection wellhead equipment 126 for injection into the injection well 104. The injected fluid is stored in the reservoir 112.

Environmental regulations, standards, or criteria can specify that the second separated fluid portion to be injected into the injection well 104 for storage in the reservoir 112 should not include concentrations of certain types of particles that exceed specific thresholds. The particles can include fluid particles (e.g. oil droplets or other types of fluid particles) and/or solid particles (e.g. sand particles or other types of solid particles).

As an example, although the second separated fluid portion that is supplied by the fluid separator 118 into the injection flow conduit 124 includes primarily water, the second separated fluid portion can also include other particles, such as oil droplets and sand particles. If the concentrations of such other particles exceed specified thresholds, then violations of environmental regulations, standards, or criteria may occur. Also, excessive concentrations of certain particles may cause clogging of the injection well 104.

Based on the monitoring performed according to some implementations, actions can be taken in response to parameters associated with the monitored fluid not meeting thresholds.

In accordance with some implementations, a remote imaging-based measurement device 128 can be provided to measure the content of the second separated fluid portion in the injection flow conduit 124. The imaging-based measurement device 128 includes a light source (or multiple light sources) and an image sensor (or multiple image sensors).

Measurement data acquired by the imaging-based measurement device 128 can be used to determine one or more characteristics of the second separated fluid portion in the injection flow conduit 124. Such characteristics can include any or some combination of the following: a concentration of a particle (fluid particle and/or solid particle), a size of a particle, a type of a particle, a shape of a particle, a flow rate of the second separated fluid portion, and a velocity of a particle. The flow rate of a fluid portion can be derived from the velocity of a particle (or velocities of particles) in the fluid portion.

The imaging-based measurement device 128 is part of a fluid measurement system that is able to employ any of various particle measurement techniques. The particle measurement techniques can employ any or some combination of the following: high-speed imaging, multiple exposure imaging, and fluorescence imaging (discussed further below). The particle measurement system is able to determine quantities of particles (e.g. concentrations of particles, density of particles, composition of a fluid, flow rate of a fluid, velocities of particles, etc.). The particle measurement system can also provide information that can be displayed for viewing by users. Determining a velocity of a particle in the fluid portion in the injection fluid conduit 124 can include determining an instantaneous velocity of the particle within a specified time window.

In some implementations, the imaging-based measurement device 128 includes an imaging processor to perform analysis of measurement data collected by the image sensor(s) in the imaging-based measurement device 128, to determine one or more characteristics of the fluid portion in the injection flow conduit 124.

In some implementations, the fluid measurement system can further include a surface controller 130, which can be provided on the marine vessel 122. The surface controller can include a computer or an arrangement of computers. Personnel on the marine vessel 122 can interact with the surface controller 130.

The surface controller 130 can also perform analysis to perform determination of one or more characteristics of the fluid portion in the injection flow conduit 124. In some examples, raw measurement data collected by the imaging-based measurement device 128 can be communicated to the surface controller 130 over a communication link 129 (e.g. electrical link, optical link, etc.). The surface controller 130 can apply processing of the raw measurement data to determine the one or more characteristics of the fluid portion in the injection flow conduit 124.

In further examples, the output produced by the imaging processor in the imaging-based measurement device 128 can be communicated to the surface controller 130 over the communication link 129. This output can include characteristics of the fluid portion in the injection flow conduit 124 as determined by the imaging processor of the imaging-based measurement device 128.

In accordance with some implementations, measurements made by the fluid measurement system (which can include the imaging-based measurement device 128 and the surface controller 130) can be performed in real time as fluid flows through the injection flow conduit 124. Performing the measurements in real time can refer to acquiring measurement data relating to the fluid portion in the injection flow conduit 124 as the fluid portion flows in the injection flow conduit 124. In further implementations, the determination of one or more characteristics of the fluid portion in the injection flow conduit 124 can also be performed in real time, as the measurement data is acquired by the imaging-based measurement device 128.

Although not shown, the arrangement shown in FIG. 1 can include other measurement devices, including sensors, test devices, and so forth, to monitor fluid flow in various parts of the production and/or injection arrangement.

Also, although reference is made to measuring content of a fluid portion in the injection flow conduit 124, it is noted that in other implementations, the fluid measurement system can be used to measure content of fluid flow in other flow conduits, such as the flow conduit 116, the product flow conduit 120, a tubing in the production well 102, a tubing in the injection well 104, and so forth.

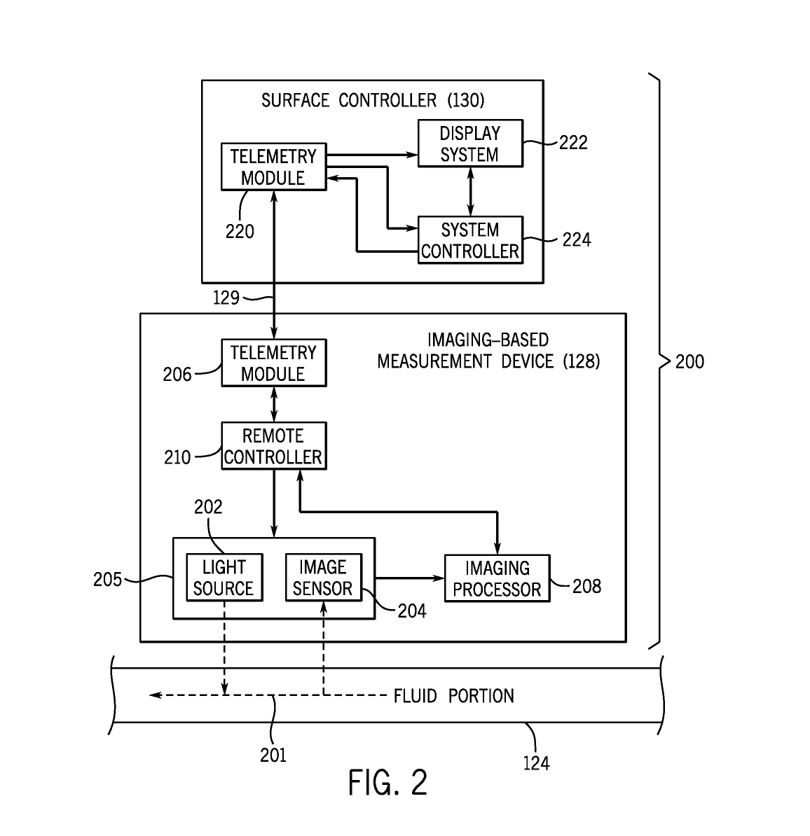

FIG. 2 shows an example of a fluid measurement system 200 that includes the remote imaging-based measurement device 128 and the surface controller 130. The remote imaging-based measurement device 128 is used to measure content of a fluid portion 201 that flows through the injection flow conduit 124 (or another flow conduit).

The remote imaging-based measurement device 128 includes a light source 202 and an image sensor 204. Note that although reference is made to a single light source 202 and a single image sensor 204, other implementations of the imaging-based measurement device 128 can employ multiple light sources and/or multiple image sensors. The light source(s) 202 and the image sensor(s) 204 are part of a remote monitoring sensing unit 205.

The light source 202 can include a laser source, a high intensity light source (such as a halogen lamp, etc.), or any other type of light source. The image sensor 204 can include a camera that is used to capture an image of fluid flowing through the flow conduit 124, or any other type of image sensor. As examples, the image sensor 204 can include a CMOS (complementary metal-oxide-semiconductor) image sensor, a CCD (charge-coupled device) camera, and so forth.

The remote monitoring sensing unit 205 may be provided with a high speed capability for measuring high speed particle movement. High speed particle movement may be at speeds of, for example, up to about 3 meters per second (m/s). As examples, the camera 204 can be provided with a fast shutter speed, or the light source 202 can be provided with the ability to generate fast strobe light pulses. A shutter speed relates to a length of time that the shutter of the camera 204 is open when acquiring an image. A fast shutter speed refers to a speed of the camera shutter that is able to image high speed movement of particles in the fluid portion 201, without blurring. For example, the camera may be able to take millions of frames per second. In other examples, the camera may be able to take hundreds or thousands of frames per second.

The light source 202 is able to produce a sequence of light pulses, where the time interval between the light pulses can be short enough to adequately image high speed movement of particles in the fluid portion 201. An example of the light source 202 that can provide fast strobe light pulses can include a high frequency pulsed laser source using Particle Image Velocimetry (PIV). For example, the light pulses can be generated at a frequency greater than about 10 megahertz (MHz). PIV may be used to perform quantitative measurement of fluid velocity at multiple points. PIV may employ a double-exposure (or multiple exposure) technique using a high frequency pulsed laser source and/or a multiple wavelength laser source pulsed with a single camera exposure. Various algorithms can be used to measure velocity of each particle in a flow of the fluid portion 201.

The imaging-based measurement device 128 includes a telemetry module 206, which is able to communicate data over the communication link 129 with the surface controller 130.

Raw measurement data acquired by the remote monitoring sensing unit 205 (more specifically, the image sensor 204) can be provided to an imaging processor 208. The imaging processor 208 can process the raw measurement data from the remote monitoring sensing unit 205 to determine one or more characteristics of the fluid portion 205, as discussed above. In some examples, the raw measurement data can also be sent by the telemetry module 206 over the communication link 129 to the surface controller 130.

The remote monitoring sensing unit 205 is operatively coupled to the fluid portion 201 flowing in the flow conduit 124. For example, the remote monitoring sensing unit 205 can either be in contact with or located at least partially inside the flow conduit 124.

The imaging processor 208 can perform real-time measurements. In some examples, the imaging processor 208 can use high-speed vision pixel massively parallel processing to process measurement data from the remote monitoring sensing unit 205 to determine the characteristics of the fluid portion 201.

Examples of image processing that can be performed by the imaging processor 208 include image processing described in any of the following: U.S. Publication No. 2013/0265409; Yoshihiro Watanabe et al., “Real-Time Visual Measurements Using High-Speed Vision,” Proceedings of SPIE Vol. 5603, 2004. In other examples, other image processing techniques can be applied.

In some examples, the imaging processor 208 is located in situ with the remote monitoring sensing unit 205. For example, the imaging processor 208 can be part of the same module (located within a housing of the module) as the remote monitoring sensing unit 205. As another example, the imaging processor 208 can be mounted on a common circuit board as the remote monitoring sensing unit 205.

The imaging-based measurement device 128 can also include a remote controller 210, which can control the remote monitoring sensing unit 205 and the imaging processor 208. Also, as shown in FIG. 2, communications through the telemetry module 206 also pass through the remote controller 210. In other examples, the remote controller 210 is not in the data path with the telemetry module 206.

The remote controller 210 can control when the remote monitoring sensing unit 205 and/or the imaging processor 208 are activated. Moreover, the remote controller 210 can communicate over the communication link 129 with the surface controller 130. The surface controller 130 can send commands to the remote controller 210 to control acquisition of measurement data and processing of the measurement data.

The surface controller 130 includes a telemetry module 220 to allow the surface controller 130 to communicate over the communication link 129 with the remote imaging-based measurement device 128. In addition, the surface controller 130 includes a display system 222. Data received by the telemetry module 220 from the remote imaging-based measurement device 128 can be passed for display by the display system 222. The displayed data can include various characteristics determined by the imaging processor 208.

In response to the displayed data, a user (e.g. operator) can take appropriate action. For example, the user can issue a command to a system controller 224 in the surface controller 130. In response, the system controller 224 can send a correspond command to the remote imaging-based measurement device 128 or to another remote module to cause an action to be performed.

Data received by the telemetry module 220 from the remote imaging-based measurement device 128 can also be passed to the system controller 224. The received data can include information pertaining to characteristics of the fluid portion 201 as determined by the imaging processor 208, or the received data can include raw measurement data from the remote monitoring sensing unit 205. Based on the received data, the system controller 224 can determine whether an alarm or other notification should be generated to a user (the alarm or other notification can be displayed by the display system 222. As further examples, based on the received data, the system controller 224 can determine whether another action should be taken. For example, the system controller 224 can automatically generate a command to the imaging-based measurement device 128 or another module, such as if an emergency or other urgent condition is indicated by the received data.

If the received data is raw measurement data, the system controller 224 can also perform analysis to determine one or more of characteristics of the fluid portion 201 in the flow conduit 124.

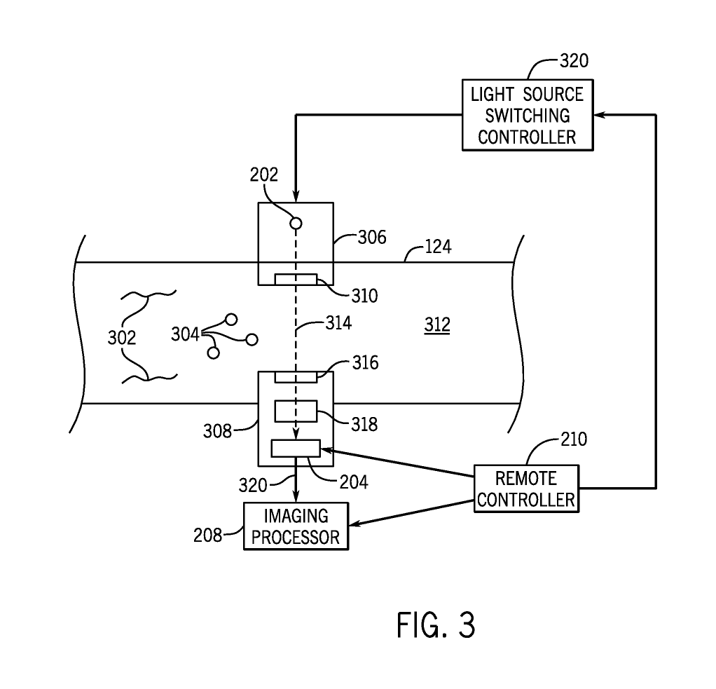

FIG. 3 is a schematic diagram showing an example arrangement for measuring content of the fluid portion in the flow conduit 124. In some examples, the content of the fluid portion in the flow conduit 124 can include water 302 and various particles 304, which can include fluid particles and/or solid particles.

In FIG. 3, the remote monitoring sensing unit 205 of FIG. 2 can include a light source unit 306 and a sensor unit 308. The light source unit 306 includes the light source 202, while the sensor unit 308 includes the image sensor 204. In the example of FIG. 3, portions of the remote monitoring sensing unit 205 are provided inside the flow conduit 124. In other examples, the light source unit 306 and the sensor unit 308 can be in contact with but not inside the flow conduit 124.

The light source unit 306 includes an optical window 310 through which light emitted by the light source 202 can pass into the inner chamber 312 of the flow conduit 124, as indicated by an arrow 314 in FIG. 3.

The image sensor unit 308 also includes an optical window 316, through which light emitted by the light source 202 that has passed through the fluid portion in the inner chamber 312 of the flow conduit 124 can pass to a lens 318 of the image sensor unit 308. The light that has passed through the optical window 316 and the lens 318 is received by the image sensor 204.

The lens 318 can perform magnification so that relative small particles (particles of less than 10 micrometers or pm in size) can be magnified for more accurate image processing.

In some examples, the image windows 310 and 316 can be formed of sapphire or any other type of transparent material. The optical windows 310 and 316 can be used as contact windows with the fluid flow in the flow conduit 124. The optical windows 310 and 316 also serve to seal and protect other components in the units 306 and 308. For example, the optical windows 310 and 316 can protect the other components in the units 306 and 308 from high pressure (e.g. greater than about 10 kpsi) and high temperature (e.g. greater than about 100° C.).

In response to the received light, the image sensor 204 produces measurement data 320 that is sent to the imaging processor 208. After processing of the raw measurement data from the image sensor 204, the output information produced by the imaging processor 208 can be communicated by the telemetry module 206 to the surface controller 130 (FIG. 2), in some examples.

As further shown in FIG. 3, a light source switching controller 320 is provided to control the switching of the light source 202. The light source switching controller 320 can be under control of the remote controller 210 of the imaging-based measurement device 128. In some examples, the light source switching controller 320 can include fast switch laser diode drivers. The remote controller 210 can also control the image sensor 204 and the imaging processor 208, as noted above. In this way, the remote controller can ensure synchronization between the light source 202 and the image sensor 204 and imaging processor 208.

In other examples, instead of arranging the light source unit 306 and the sensor unit 308 on opposite sides of the flow conduit 124, it is noted that the light source unit 306 and the sensor unit 308 can be arranged on the same side of the flow conduit 124. In these latter examples, light emitted from the light source 202 can be reflected from the fluid portion and captured by the image sensor 204.

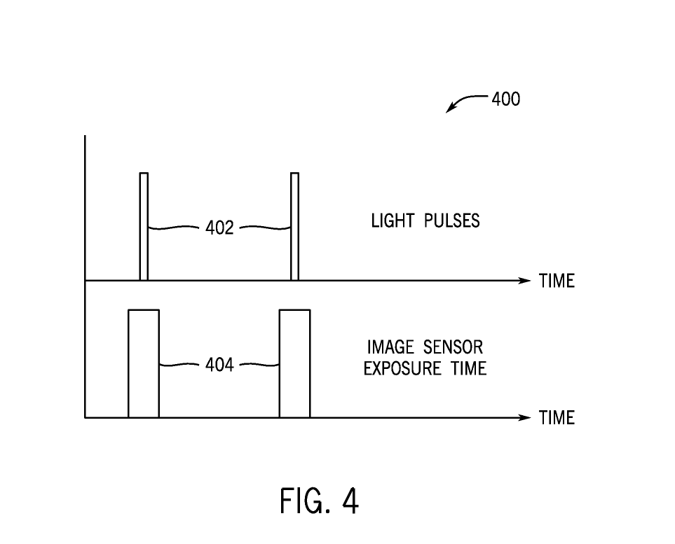

FIG. 4 is a graph 400 that shows light pulses 402 emitted by the light source 306 of FIG. 3. The light source switching controller 320 controls activation of the light source 202 to produce each respective light pulse 402. When the light source switching controller 320 deactivates the light source 202, no light is emitted by the light source 202.

FIG. 4 also shows exposure time windows 404 relating to when the image sensor 204 is activated to measure light that has been emitted by the light source 202 and that has passed through the fluid portion in the flow conduit 124 of FIG. 3. The exposure time windows 404 are controlled by the remote controller 210. The remote controller 210 can activate the image sensor 204 for a duration of each of the time windows 404 to cause the image sensors 204 to acquire an image. The remote controller 210 deactivates the image sensor 204 at other times.

Each light pulse 402 has a specified width and each exposure time window 404 has a time length that is based on a frame rate of the image sensor 204 as controlled by the remote controller 210.

In a specific example, it is assumed that a maximum particle velocity is 4.5 m/s, the image sensor 204 has a pixel ratio (P) of 10 pixels/μm, and a particle has a size of 1 μm. In this example, a particle will displace 45,000 pixels in 1 millisecond (ms). To keep the image captured by the image sensor 204 from blurring within one pixel, a shutter speed of 0.001/45000 (22 nanoseconds or ns) can be used. Although reference is made to a specific example, it is noted that other examples are also contemplated.

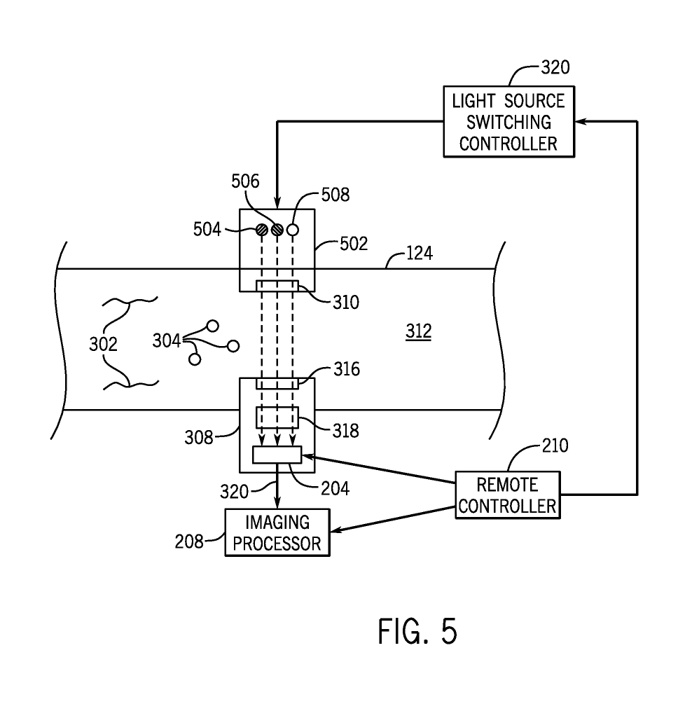

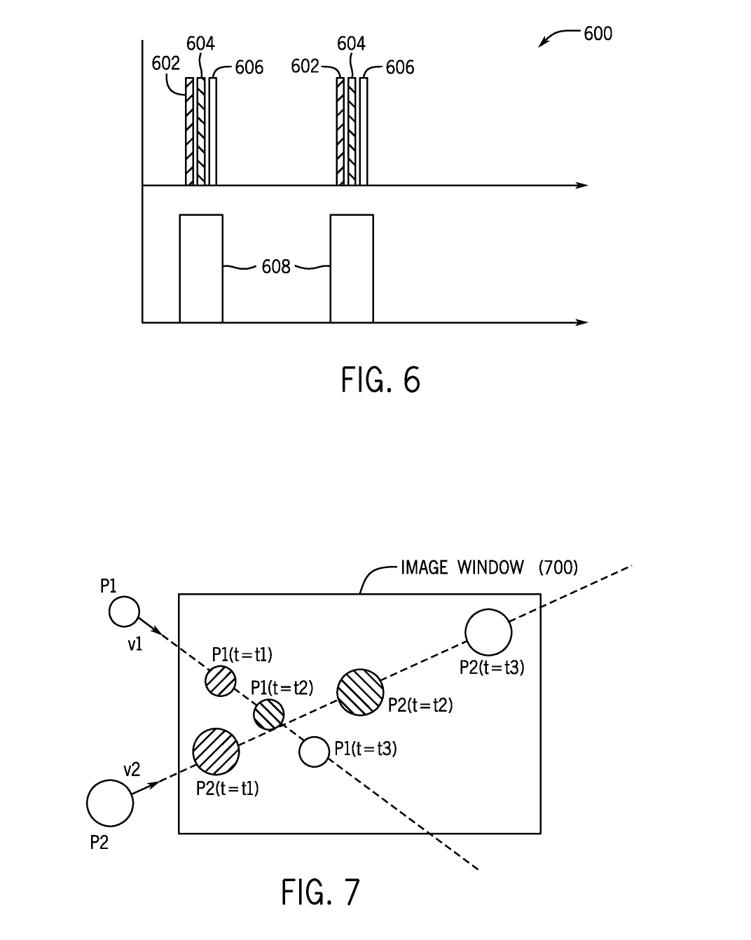

To measure the velocity of multiple particles, multiple exposures using light pulses of multiple wavelengths can be used, as discussed in connection with FIGS. 5 and 6. In FIG. 5, the remote monitoring sensing unit 205 of FIG. 2 includes a light source unit 502 and the image sensor unit 308 (which is configured to be similar to the image sensor unit 308 of FIG. 3).

The light source unit 502 includes multiple light sources (e.g. multiple laser sources) that can emit respective light at different discrete wavelengths. For example, the light source 504 can emit light in a first wavelength, e.g. a wavelength corresponding to red light). The light source 506 can emit light in a second, different wavelength, e.g. the wavelength corresponding to green light. The light source 508 can emit light at yet another different wavelength, e.g. the wavelength corresponding to blue light.

Light emitted by each of the light sources 504, 506, and 508 is passed through the optical window 310 of the light source unit 502 and through the fluid portion in the fluid conduit 124. The light from the light sources 504, 506, and 508 is then passed through the image window 316 of the image sensor unit 308, and through the lens 318 to the image sensor 204.

FIG. 6 is a graph 600 that depicts light pulses 602 of a first wavelength emitted by the light source 204, light pulses 604 of a second wavelength emitted by the light source 506, and light pulses 606 of a third wavelength emitted by the light source 508. In addition, the graph 600 of FIG. 6 shows exposure time windows 608 of the image sensor 204 for capturing light corresponding to the light pulses 602, 604, and 606, after passing through fluid portion in the flow conduit 124.

Using the remote monitoring sensing unit 205 of FIG. 6, an original image is captured by multiple exposures in response to multiple wavelength light pulses. The captured image is represented by an image window 700 in FIG. 7. In the example, it is assumed there are particles P1 and P2 traveling at respective velocities v1 and v2.

Each particle is imaged in response to light pulses of three different wavelengths from the respective light sources 504, 506, and 508. An image of particle P1 responsive to the light pulse from the light source 504 is captured at time t=t1. An image of particle P1 responsive to the light pulse from the light source 506 is captured at time t=t2. An image of particle P1 responsive to the light pulse from the light source 508 is captured at time t=t3.

Similarly, an image of particle P2 responsive to the light pulse from the light source 504 is captured at time t=t1. An image of particle P2 responsive to the light pulse from the light source 506 is captured at time t=t2. An image of particle P2 responsive to the light pulse from the light source 508 is captured at time t=t3.

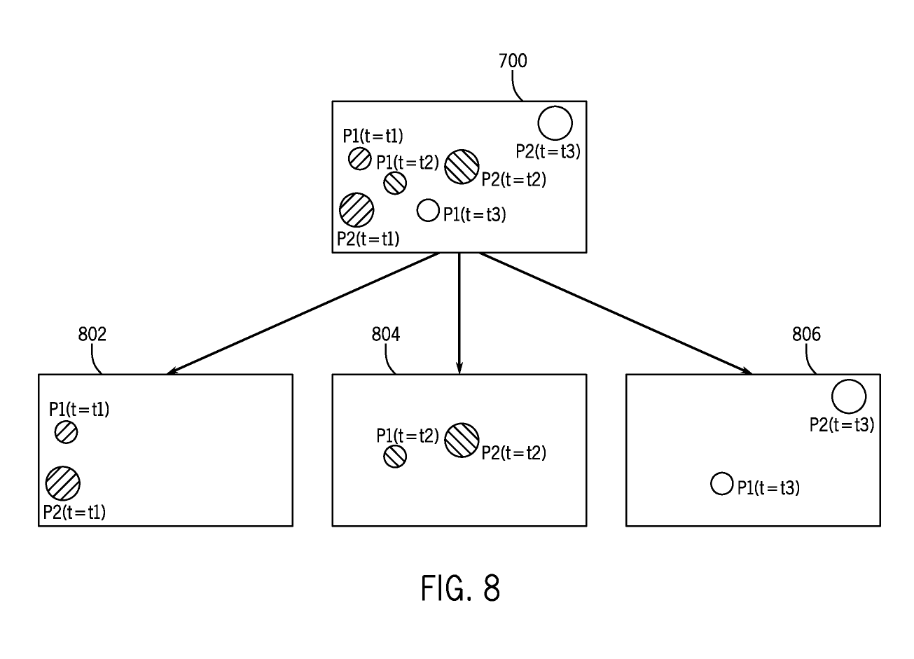

The image window 700 can then be filtered (such as by using color filters of the imaging processor 208) into separate window images 802, 804, and 806 according to the wavelength information (color) of each image as shown on FIG. 8. For example, the window image 802 may be captured when illuminated with the red color laser source 504, the window image 804 may be captured when illuminated with the green laser source 506, and the window image 806 may be captured when illuminated with the blue laser source 508.

Particles P1 and P2 can be tracked using a high-speed tracking algorithm, such as using the algorithm described in Yoshihiro Watanabe et al., referenced above. The velocity of the particle P1 during the time period starting at time t1 and ending at time t2 can be derived from a displacement distance of the particle P1 during the time period, divided by the time period (t2−t1). The velocity of the particle P1 during the time period starting at time t2 and ending at time t3 can be derived in similar fashion. The velocities of the particle P1 in the different time periods can be aggregated (e.g. averaged) to derive an estimate of the particle P1.

The velocity of the particle P2 can be derived in the same way.

Particles may also be tracked using a high-speed pixel parallel processing algorithm. This algorithm may be used to track multiple target particles, along with the shape and size of each particle. In addition, a count of the number of particles of each respective size can be tracked, such that a distribution of multiple particle sizes can be derived.

Additional information concerning the particles, such as particle type, may be determined from the images. The particle type may be differentiated based on an intensity of a particle, a shape of the particle, movement (velocity) of the particle, and so forth. For example, sand particles may cause captured light to have a darker intensity as no light can pass through the sand particles (assuming back illumination is used where light from a light source passes through the fluid portion containing the particles to the image sensor on the other side). On the other hand, oil droplets may have a lighter intensity, since some portion of light can pass through the oil droplets.

The imaging processor 208 discussed above can use the detected light intensity information to differentiate between particles types. As further examples, the imaging processor 208 can use shapes of particles to differentiate between different types of particles. Oil droplets may be spherical in shape, while sand particles may have irregular shapes. The movement (e.g. velocity vector) of each particle may also be used to differentiate between different types of particles. Oil droplets and sand particles may exhibit different movements.

In further implementations, the remote monitoring sensing unit 205 can employ fluorescence measurement to discriminate different types of particles, such as between oil droplets and other particles. Devices, such as an IN SITU FLUID ANALYZER™ commercially available from the Schlumberger Technology Corporation™ may be used. Ultraviolet light or blue light may be used to illuminate the particles, and the fluorescence property of each particle responsive to the ultraviolet or blue light can be measured. An oil droplet may have more fluorescence compared to a sand particle, for example.

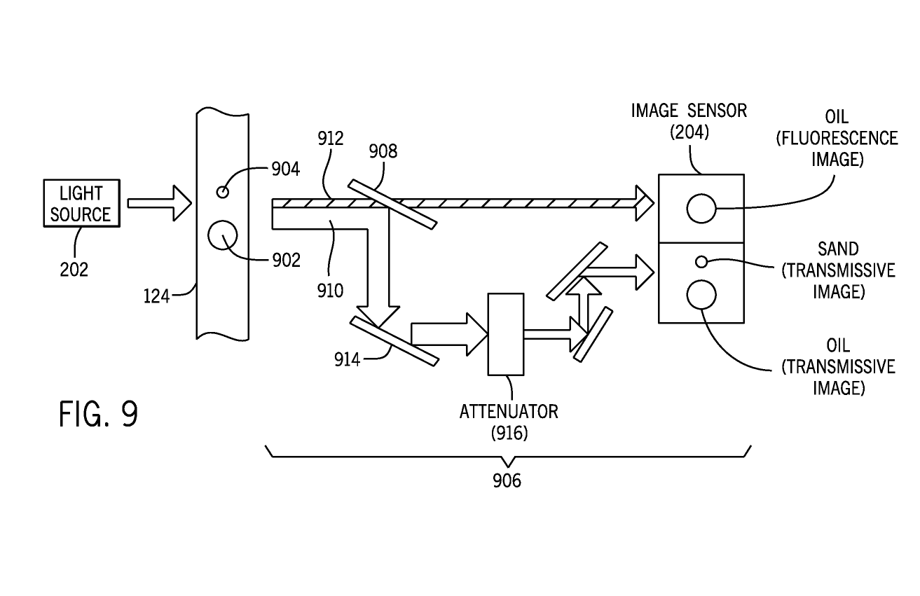

FIG. 9 shows an example of the remote monitoring sensing unit 205 that uses fluorescence detection, in accordance with some implementations. The light source 202 produces ultraviolet or blue light, which is passed through the fluid portion in the flow conduit 124 to a fluorescence sensor unit 906. The fluid portion in the flow conduit 124 includes an oil droplet 902 and a sand particle 904.

An optical diverter 908 receives light from the light source 202 that has passed through the fluid portion containing the particles 902 and 904. The optical diverter 908 can selectively divert portions of the received light. The mirror 908 can include, for example, a dichotic mirror that reflects a first light portion 910 of the received light and permits a second light portion (fluorescent light portion) 912 of the received light to pass through to the image sensor 204.

The reflected first light portion 910 of the received light is reflected by a reflector 914 to an optical attenuator 916. The optical attenuator 916 attenuates the power level of the first light portion, and then directs the attenuated first light portion (through one or more intermediate reflectors) to the image sensor 204.

The fluorescence of the oil droplet 902 responsive to the ultraviolet or blue light emitted by the light source 202 has a longer wavelength. Note that the power level of the fluorescent light portion 912 may be less than the first light portion reflected from the diverter 908. As a result, the optical attenuator 916 is used to reduce the power level of the first light portion to be similar to the power level of the fluorescent light portion 912 received by the image sensor 204.

As shown in the example of FIG. 9, a particle image with fluorescent characteristics may be detected in an upper side of the image sensor 204, and a particle image with ultraviolet or blue light may be detected in a lower side of the image sensor 204.

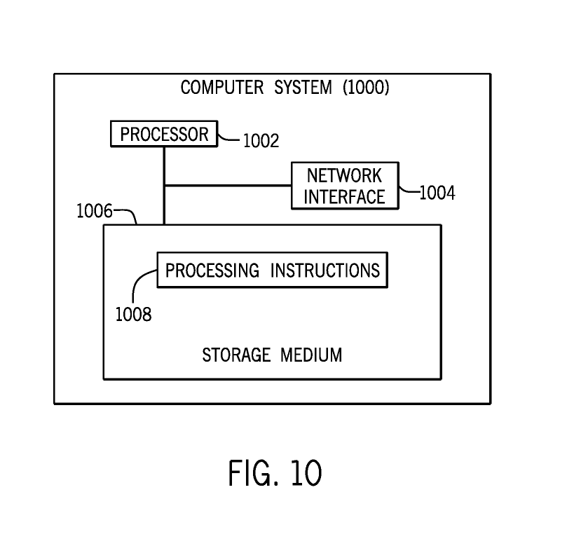

FIG. 10 is a block diagram of a computer system 1000, which can be used to implement the imaging processor 208 and/or the surface controller 130 in some examples. The computer system 1000 includes a processor 1002 (or multiple processors). A processor can include a microprocessor, a microcontroller, a physical processor module or subsystem, a programmable integrated circuit, a programmable gate array, or another physical control or computing device.

The processor(s) 1002 can be coupled to a network interface 1004 and a non-transitory machine-readable or computer-readable storage medium (or storage media) 1006.

The storage medium (or storage media) 1006 can store processing instructions 1008 to apply processing as performed by the imaging processor 208 and/or the surface controller 130.

The storage medium (or storage media) 1006 include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
a fluid separator to separate a fluid flow into a plurality of fluid portions, and to deliver at least a first fluid portion of the plurality of fluids to a flow conduit; and
an imaging-based measurement device comprising a light source and an image sensor, the imaging-based measurement device to measure the first fluid portion in the flow conduit.

2. The apparatus of claim 1, wherein the imaging-based measurement device further comprises an imaging processor to process measured data from the image sensor to determine a characteristic of the first fluid portion.

3. The apparatus of claim 2, wherein the imaging-based measurement device further comprises a telemetry module to send either raw measurement data acquired by the image sensor or processed data produced by the imaging processor to a controller over a communication medium.

4. The apparatus of claim 2, wherein the determined characteristic of the first fluid portion comprises a flow rate of the first fluid portion or a velocity of a particle.

5. The apparatus of claim 2, wherein the determined characteristic of the first fluid portion is selected from the group consisting of a concentration of a particle, a size of the particle, a shape of the particle, and a type of the particle.

6. The apparatus of claim 5, wherein the particle comprises a fluid particle or a solid particle.

7. The apparatus of claim 1, wherein the imaging-based measurement device comprises an optical window through which light is able to pass to allow for measurement of the first fluid portion.

8. The apparatus of claim 1, wherein the image sensor comprises a camera having a shutter speed set to capture images of the first fluid portion moving up to a specified flow rate.

9. The apparatus of claim 1, wherein the light source is to generate light pulses at a rate to capture images of the first fluid portion moving up to a specified flow rate.

10. The apparatus of claim 1, comprising a plurality of light sources to emit respective light pulses at a plurality of different discrete wavelengths.

11. The apparatus of claim 10, wherein the imaging-based measurement device further comprises color filters to separate an image captured in response to the emitted light at the plurality of different discrete wavelengths into a plurality of images corresponding to different colors of the respective plurality of different discrete wavelengths.

12. The apparatus of claim 1, wherein the light source is to emit ultraviolet or blue light, and the image sensor is to detect fluorescence of a particle in the first fluid portion.

13. The apparatus of claim 1, wherein the fluid separator and the imaging-based measurement device are part of a subsea fluid production system.

14. A method comprising:
measuring, by an imaging-based measurement device comprising light sources and an image sensor, content of a fluid portion in a flow conduit, the light sources to emit light at different wavelengths; and
determining, by the imaging-based measurement device based on measurement data from the image sensor that is responsive to light from the light sources, characteristics of particles in the fluid portion.

15. The method of claim 14, further comprising using the determined characteristics to differentiate between different types of particles in the fluid portion.

16. The method of claim 15, wherein the characteristics comprise one or more of light intensities of the particles, movement of the particles, and shapes of the particles.

17. The method of claim 14, further comprising:
separating, by a fluid separator, a fluid flow into a plurality of fluid portions including the fluid portion directed by the fluid separator to the flow conduit; and
injecting the fluid portion from the flow conduit into an injection well.

18. The method of claim 17, wherein the fluid flow is from a production well.

19. The method of claim 14, further comprising:
sending, by the imaging-based measurement device over a communication link, information relating to the characteristics of the particles to a controller.

20. An article comprising at least one non-transitory machine-readable storage medium storing instructions that upon execution cause a system to:
receive measurement data acquired by an imaging-based measurement device comprising a light source and an image sensor, the imaging-based measurement device to measure a fluid portion in a flow conduit, the fluid portion separated from a fluid flow by a fluid separator; and
process, using an imaging processor in the imaging-based measurement device, the measurement data to determine a characteristic of the fluid portion.
